(19) United States
(12) Patent Application Publication
(10) Pub. No.: US 2026/0112736 A1
(43) Pub. Date: Apr. 23, 2026

(54) MITIGATION OF THERMAL RUNAWAY PROPAGATION USING MULTIPLE BRANCH COOLANT SYSTEM

(71) Applicant: GM GLOBAL TECHNOLOGY OPERATIONS LLC, Detroit, MI (US)

(72) Inventors: Philip J. Prociw, Clinton Township, MI (US); Justin A. Bunnell, Cary, NC (US); Andres V. Mituta, Lake Orion, MI (US); Benjamin C. Groen, Troy, MI (US); Andrew J. Cornelli, Rochester Hills, MI (US)

(73) Assignee: GM GLOBAL TECHNOLOGY OPERATIONS LLC, Detroit, MI (US)

(21) Appl. No.: 18/918,142

(22) Filed: Oct. 17, 2024

(51) Int. Cl. H01M 10/6568; H01M 10/48; H01M 10/613; H01M 10/625; H01M 10/63; H01M 50/249

(52) U.S. Cl. CPC H01M 10/6568; H01M 10/486; H01M 10/613; H01M 10/625; H01M 10/63; H01M 50/249

(57) ABSTRACT

A thermal runaway propagation (TRP) mitigation system for a multi-cell rechargeable energy storage system (RESS) with battery cells arranged in individual battery modules includes a cooling subsystem. The cooling subsystem has a main coolant loop circulating coolant and multiple coolant branches arranged in parallel. Each coolant branch receives a portion of the coolant from the main coolant loop to adjust temperature of one battery module. The cooling subsystem also has flow-valve(s) regulating and distributing the coolant from the main loop across the branches. The TRP mitigation system also includes an electronic controller for detecting an onset of thermal runaway in the RESS and identifying a thermally affected battery module and an associated coolant branch. The controller also shuts off coolant flow into coolant branches not associated with the thermally affected battery module to exclusively cool the thermally affected battery module and thereby mitigate the TRP in the RESS.

### INTRODUCTION

The present disclosure relates to mitigation of thermal runaway propagation in a multi-cell rechargeable energy storage system (RESS) using a multiple branch coolant system.

Typically, an electric energy generation and storage battery system includes one or more battery cells for powering a load. A plurality of battery cells may be arranged in close proximity to one another to generate a battery module and a plurality of battery modules may be organized into a battery pack array. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Exposure of a battery cell to elevated temperatures over prolonged periods may cause the cell to experience a thermal runaway event, where heat build-up in an individual cell leads to the heat spreading to adjacent cells in the module and affecting the entire battery array. Accordingly, thermal energy needs to be effectively removed to mitigate heat build-up and consequent degradation of battery system performance. Generally, devices such as heat-sinks or cold-plates with circulating coolant are employed to remove heat from battery systems.

### SUMMARY

A thermal runaway propagation (TRP) mitigation system for a multi-cell rechargeable energy storage system (RESS) having a plurality of battery cells arranged in individual battery modules includes a cooling subsystem. The cooling subsystem has a main coolant loop circulating coolant and a plurality of coolant branches arranged in parallel. Each coolant branch receives a portion of the coolant from the main coolant loop to adjust the temperature of one battery module. The cooling subsystem also has flow-valve(s) for regulating and distributing the coolant from the main coolant loop across the coolant branches. The TRP mitigation system also includes an electronic controller in operative communication with the cooling subsystem and configured to detect an onset of a thermal runaway event in the RESS. The controller is also configured to identify a battery module in the RESS exhibiting the onset of a thermal runaway event and identify a coolant branch associated with the subject battery module. The controller is further configured to shut off, via the flow-valve(s), a flow of the coolant into coolant branches not associated with the battery module exhibiting the onset of a thermal runaway event to exclusively cool the battery module exhibiting the onset of a thermal runaway event and thereby mitigate the TRP in the RESS.

The electronic controller may be additionally configured to set an alert indicative of the identified battery module exhibiting the onset of a thermal runaway event.

Each battery module may include a respective temperature sensor in communication with the electronic controller and configured to detect an onset of a thermal runaway event in the corresponding battery module.

Following the shut off of the flow of the coolant into coolant branches not associated with the battery module exhibiting the onset of a thermal runaway event, the electronic controller may be configured to detect degradation of conditions, e.g., a temperature increase, indicative of the onset of a thermal runaway event in the identified battery module. Additionally, the electronic controller may be configured to open, via the flow-valve(s), a flow of the coolant into coolant branch(s) associated with battery module(s) neighboring the battery module exhibiting the onset of a thermal runaway event to further mitigate the TRP in the RESS.

The electronic controller may be additionally configured to shut off coolant flow into the coolant branch associated with the battery module exhibiting the onset of a thermal runaway event when the subject battery module is identified as having entered full thermal runaway. Such shut off of coolant flow into the affected battery module is intended to increase coolant flow into a coolant branch associated with the neighboring battery module and forestall TRP.

Following the shut off of the flow of the coolant into coolant branches not associated with the battery module exhibiting the onset of a thermal runaway event, the electronic controller may also be configured to identify an additional battery module in the RESS exhibiting the onset of a thermal runaway event. The electronic controller may be additionally configured to open, via the flow-valve(s), flow of the coolant into each coolant branch associated with the respective battery modules in the RESS.

The flow-valve may be a multi-way valve assembly arranged in a junction between the main coolant loop and the plurality of coolant branches. Such a multi-way valve may be configured to control the flow of the coolant into each of the coolant branches.

Alternatively, a plurality of throttle valves may regulate the flow of the coolant from the main coolant loop. Each throttle valve may be arranged in one of the coolant branches upstream of the corresponding battery module and be configured to control the flow of the coolant into the subject coolant branch.

Each coolant branch may include a one-way valve configured to control the flow of the coolant out of the subject coolant branch.

The cooling subsystem may also include a fluid pump configured to circulate the coolant through the main coolant loop.

A motor vehicle employing a thermal runaway propagation (TRP) mitigation system, as described above, and a thermal runaway propagation (TRP) mitigation method for a multi-cell rechargeable energy storage system (RESS) are also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources, a multi-cell rechargeable energy storage system (RESS) configured to generate and store electrical energy used by vehicle systems, and a thermal runaway propagation (TRP) mitigation system, according to the disclosure.

FIG. 2 is a schematic illustration of the TRP mitigation system for the RESS shown in FIG. 1, including an embodiment of a cooling subsystem having a main coolant loop and multiple parallel coolant branches for removing thermal energy from individual battery modules, according to the disclosure.

FIG. 3 is a schematic illustration of the TRP mitigation system for the RESS shown in FIG. 1, including another embodiment of the cooling subsystem having a main coolant loop and multiple parallel coolant branches subsystem for removing thermal energy from individual battery modules, according to the disclosure.

FIG. 4 illustrates a thermal runaway propagation (TRP) mitigation method for the multi-cell RESS employing the coolant subsystem shown in FIGS. 1-3.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

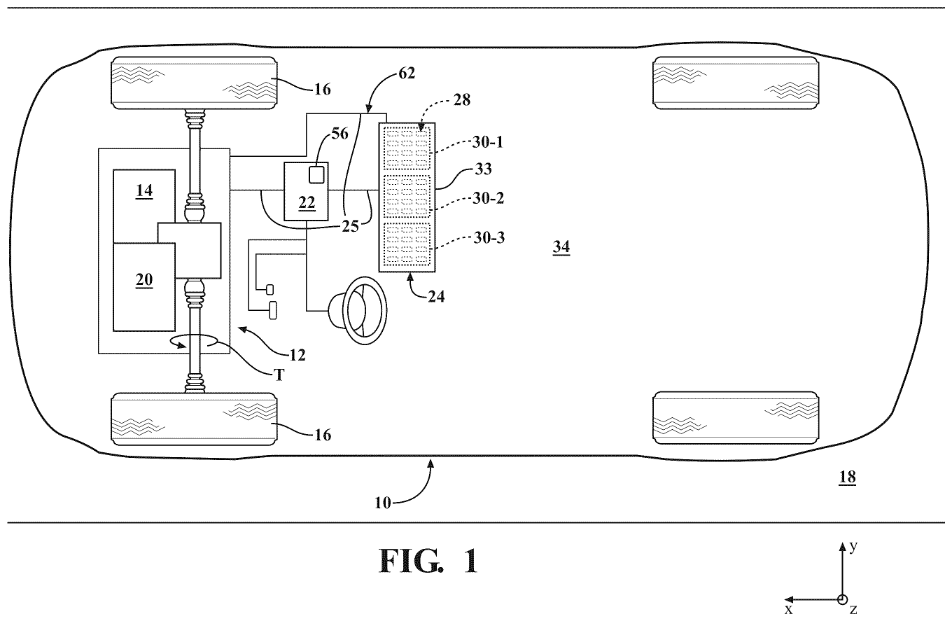

Referring to the drawings, wherein like reference numbers refer to like components, FIG. 1 shows a schematic view of a motor vehicle 10 having a powertrain 12. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator.

As shown in FIG. 1, the powertrain 12 may include an additional power-source 20, such as an internal combustion engine. The power-sources 14 and 20 may act in concert to power the vehicle 10. The vehicle 10 additionally includes a central processing unit (CPU) 22 and a multi-cell rechargeable energy storage system (RESS) 24 configured to generate and store electrical energy through heat-producing electro-chemical reactions for supplying the electrical energy to the power-sources 14 and 20. The CPU 22 regulates various systems of the vehicle 10, including the powertrain 12 to generate a predetermined amount of power-source torque T. The RESS 24 may be connected to the power-sources 14 and 20, to the electronic CPU 22, as well as to other vehicle systems via a high-voltage databus or BUS 25.

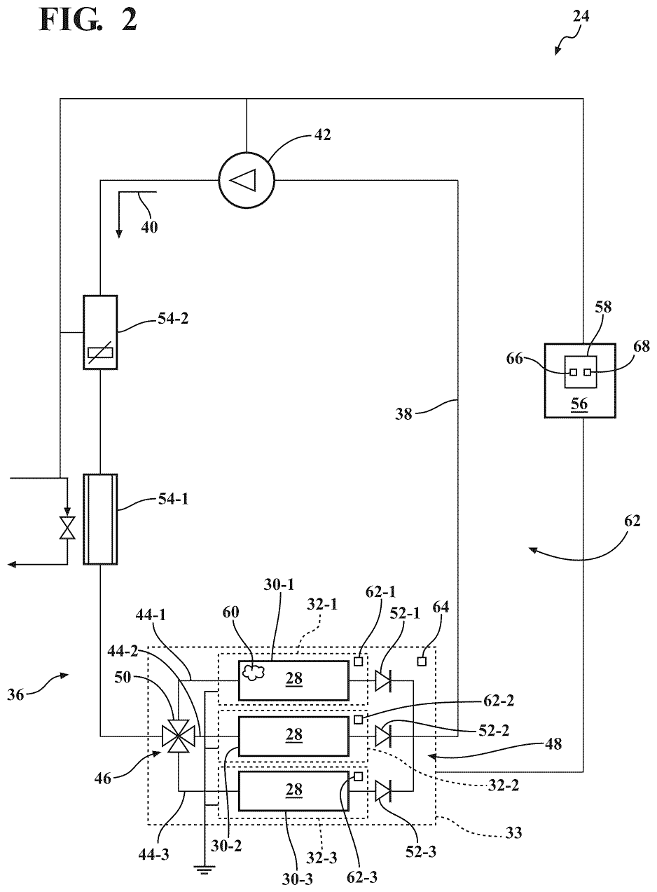

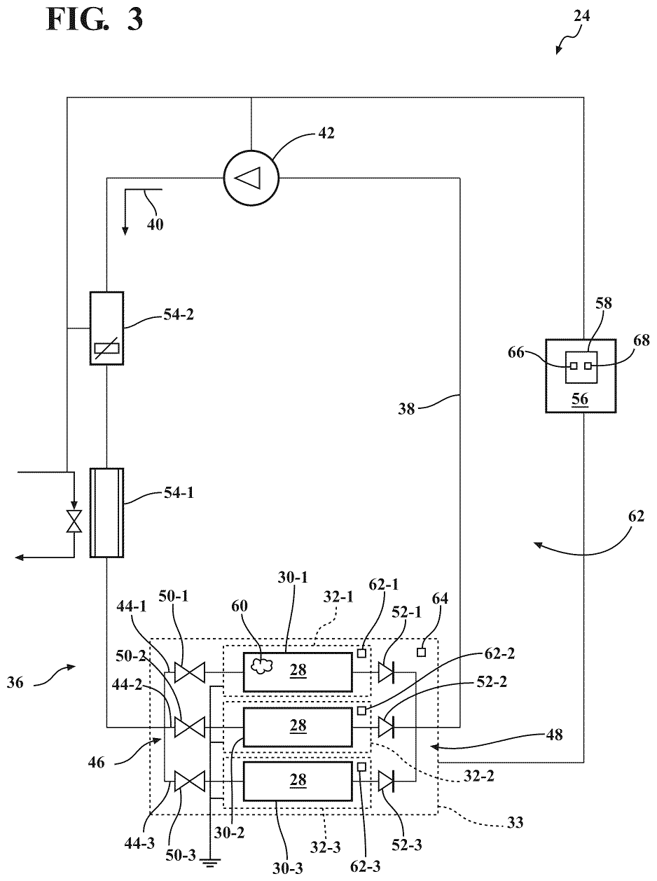

As shown in FIGS. 1-3, the RESS 24 includes a plurality of battery cells 28, such as lithium-ion rechargeable cells, arranged in individual battery groups or modules, such as a first module 30-1, a second module 30-2, and a third module 30-3. The subject modules 30-1, 30-2, 30-3 may be arranged electrically in series or in parallel. Although three individual battery modules are specifically shown, it is intended that the RESS 24 includes at least two respective modules, and multiple modules may be organized into battery packs or subpacks. The remainder of the present description will focus on RESS 24 construction having three battery modules 30-1, 30-2, 30-3, with each battery module having a desired quantity of battery cells 28. As shown in FIGS. 2 and 3, each battery module 30-1, 30-2, 30-3 includes a respective battery module enclosure 32-1, 32-2, 32-3 connected to chassis ground and configured to house and support the corresponding battery cells 28. The RESS 24 may also include a battery pack enclosure 33 surrounded by an ambient environment 34 and configured to house and support the battery modules 30-1, 30-2, 30-3 (shown in FIG. 1).

As shown in FIGS. 2 and 3, RESS 24 also includes a cooling subsystem 36 configured to remove thermal energy from various temperature sensitive components of the RESS. Cooling subsystem 36 includes a main coolant loop 38 configured to circulate a coolant 40 through the RESS 24. As shown, cooling subsystem 36 further includes a fluid pump 42 configured to circulate coolant 40 through the main coolant loop 38. The cooling subsystem 36 also includes a plurality of coolant branches, shown as a first branch 44-1, a second branch 44-2, and a third branch 44-3, in fluid communication with the main coolant loop 38. Each of the coolant branches 44-1, 44-2, 44-3 extends through a respective battery module 30-1, 30-2, 30-3, proximate and along the constituent battery cells 28.

Furthermore, each coolant branch 44-1, 44-2, 44-3 is configured to receive a portion of the coolant 40 from the main coolant loop 38. The coolant branches 44-1, 44-2, 44-3 are arranged fluidly in parallel to receive respective portions of the coolant 40. The coolant branches 44-1, 44-2, 44-3 are thereby configured to independently circulate their respective portions of the coolant 40 and adjust the temperature of the corresponding battery modules 30-1, 30-2, 30-3 (by removing or adding thermal energy). Accordingly, each coolant branch 44-1, 44-2, 44-3 passes through one of the battery module enclosures 32-1, 32-2, 32-3. As shown, the main coolant loop 38 may be in fluid communication with additional parallel coolant branches, for example to circulate the coolant through auxiliary power modules (APMs), a Battery Disconnect Unit (BDU) including various electrical switches and relays, electrical connectors, a DC/DC converter for supplying 12V/48V power to the vehicle, etc., each having a particular temperature requirement.

With continued reference to FIGS. 2 and 3, the RESS 24 may also include an inlet manifold 46 configured to connect the main coolant loop 38 to the coolant branches 44-1, 44-2, 44-3 and an outlet manifold 48 configured to connect the coolant branches back to the main coolant loop. Accordingly, the inlet and outlet manifolds 46, 48 are together configured to maintain circulation of coolant 40 through the cooling subsystem 36. The cooling subsystem 36 additionally includes at least one flow-valve 50. The flow-valve(s) 50 are configured to regulate and distribute across the individual coolant branches 44-1, 44-2, 44-3, the coolant 40 circulated through and received from the main coolant loop 38. In other words, the flow-valve(s) 50 are specifically structured and operated to provide independent regulation of coolant flow into each individual coolant branch 44-1, 44-2, 44-3.

As shown in FIG. 2, the flow-valve 50 may be a multi-way valve assembly arranged in a junction, such as the inlet manifold 46, between the main coolant loop 38 and the plurality of coolant branches 44-1, 44-2, 44-3 upstream of each battery module 30-1, 30-2, 30-3. The multi-way valve assembly embodiment of the flow-valve 50 may be configured to control the flow of coolant 40 into each of the coolant branches 44-1, 44-2, 44-3. As shown in FIG. 3, the flow-valve(s) 50 may be a plurality of individual throttle valves 50-1, 50-2, 50-3. Each subject throttle valve 50-1, 50-2, 50-3 may be arranged in one of the plurality of coolant branches 44-1, 44-2, 44-3 upstream of the corresponding battery module 30-1, 30-2, 30-3 and configured to control the flow of the coolant 40 into the subject coolant branch.

As shown in FIGS. 2 and 3, each coolant branch 44-1, 44-2, 44-3 may include a respective one-way valve 52-1, 52-2, 52-3. The one-way valves 52-1, 52-2, 52-3 are configured to prevent backflow of the coolant 40 into the corresponding coolant branches 44-1, 44-2, 44-3. Each of the one-way valves 52-1, 52-2, 52-3 is arranged aft of the flow-valve(s) 50 and downstream of the corresponding battery module 30-1, 30-2, 30-3. Accordingly, each one-way valve 52-1, 52-2, 52-3 is configured to control the flow of the corresponding portion of the coolant 40 through and out of the subject coolant branch 44-1, 44-2, 44-3. Cooling subsystem 36 may also include a plurality of heat exchangers arranged in the main coolant loop 38 to alter the temperature of the coolant 40. For example, one embodiment of such a heat exchanger may be a coolant chiller 54-1, for example, using a refrigerant, to remove thermal energy from the coolant 40 in the main coolant loop 38. Another embodiment of such a heat exchanger may be a coolant heater 54-2, for example, using electrical resistance, to add thermal energy to the coolant 40.

As shown in FIGS. 1-3, the multi-cell RESS 24 may additionally include an electronic controller 56 that may be either electronically connected to or be part of the CPU 22. The electronic controller 56 is in operative communication with the cooling subsystem 36, i.e., configured or programmed to regulate operation of the cooling subsystem, and may be structured to manage operation of the RESS 24 as a whole. As shown, the electronic controller 56 is in operative communication with the fluid pump 42, the flow-valve(s) 50, the coolant chiller 54-1, and the coolant heater 54-2. To support requisite management of the RESS 24 and/or the cooling subsystem 36, the electronic controller 56 specifically includes a processor and tangible, non-transitory memory, which includes requisite instructions programmed therein. The controller's memory may be an appropriate recordable medium that participates in providing computer-readable data or process instructions. Such a recordable medium may take many forms, including but not limited to non-volatile media and volatile media.

Non-volatile media for electronic controller 56 may include, for example, optical or magnetic disks and other persistent memory. Volatile media may include, for example, dynamic random-access memory (DRAM), which may constitute a main memory. The instructions programmed into the controller 56 may be transmitted by one or more transmission medium, including coaxial cables, copper wire and fiber optics, including the wires that comprise a system bus coupled to a processor of a computer, or via a wireless connection. Memory of the electronic controller 56 may also include a flexible disk, hard disk, magnetic tape, another magnetic medium, a CD-ROM, DVD, another optical medium, etc. The electronic controller 56 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry.

The electronic controller 56 may be configured to regulate the flow of coolant 40 into the individual battery modules 30-1, 30-2, 30-3 through the corresponding coolant branches 44-1, 44-2, 44-3 via the fluid pump 42 and the flow-valve(s) 50. Algorithm(s), indicated generally via numeral 58, required by the electronic controller 56 or accessible thereby may be stored in the memory of the controller and automatically executed to facilitate operation of the RESS 24 and/or the cooling subsystem 36. Function of the cooling subsystem 36 may be regulated by the electronic controller 56 under normal operating conditions as well as for the purpose of mitigating extreme or anomalous circumstances envisioned herein and described in detail below.

Generally, during normal operation of the RESS, coolant flow through the coolant branches 44-1, 44-2, 44-3 is effective in absorbing thermal energy released by the battery cells 28 in the individual battery modules 30-1, 30-2, 30-3. However, during extreme conditions, such as during a thermal runaway event (identified via numeral 60 in FIGS. 2 and 3), the amount of thermal energy released by the cell undergoing the event may saturate the corresponding coolant branch and exceed capacity of the associated battery module to efficiently transfer heat, e.g., from the battery pack enclosure 33 to the ambient environment 34. As a result, excess thermal energy will typically be transferred between the neighboring cells of the respective battery module and between neighboring modules, leading to propagation of the thermal runaway through the RESS 24. Accordingly, the term “thermal runaway event” generally refers to an uncontrolled increase in temperature in a battery system.

During such a thermal runaway event 60, the generation of heat within a battery system or a battery cell exceeds the dissipation of heat, thus leading to a further increase in temperature. A thermal runaway event may be triggered by various conditions within the RESS, including a short circuit inside the cell, improper cell use, physical abuse, manufacturing defects, or exposure of the cell to extreme external temperatures. For example, in the event one battery cell 28 in the first battery module 30-1, experiences the thermal runaway event 60, the excess gases generated by such an event would give rise to highly elevated internal cell pressures having tendency to rupture casing of the subject cell.

In the event of a battery cell 28 casing rupture, high-temperature gases (with temperatures up to 1,500 degrees Celsius) emitted by the subject battery cell may send cell debris through the first battery module 30-1, triggering a thermal runaway of neighboring battery cells 28 and causing thermal runaway propagation (TRP) through the first battery module. Furthermore, the thermal runaway event 60 may spread from the first battery module 30-1 to the second battery module 30-2 and trigger thermal runaway of its battery cells 28. Accordingly, such transfer of high-temperature gases and/or debris typically increases the likelihood of a chain reaction TRP in the RESS 24.

As shown in FIG. 1, the vehicle 10 also includes a TRP mitigation system 62 for the RESS 24 and the electronic controller 56 is programmed with particular algorithm(s) 58 to operate the subject TRP mitigation system. Specifically, the algorithm(s) 58 include an inventory mode configured to monitor for an onset of a thermal runaway event in the RESS 24 while flow of coolant 40 is delivered to each of the coolant branches 44-1, 44-2, 44-3. The electronic controller 56 is also configured to detect an onset of a thermal runaway event 60 in the RESS 24. Such detection of an onset of the thermal runaway event 60 may be accomplished using temperature sensors 62-1, 62-2, 62-3 arranged on the level of battery modules (within the corresponding battery module enclosures 32-1, 32-2, 32-3) and/or a sensor 64 on battery pack level (inside the enclosure 33).

The electronic controller 56 is additionally configured to identify a particular battery module 30-1, 30-2, or 30-3 exhibiting the onset of the thermal runaway event 60, i.e., identify a thermally affected module. For example, the thermally affected module may be identified via a signal communicated to the electronic controller 56 from a specific temperature sensor 62-1, 62-2, 62-3 or via a gas sensor (not shown) arranged inside the corresponding battery module enclosure 32-1, 32-2, 32-3. The onset of a thermal runaway event 60 may also be identified via the electronic controller 56 using other early indicators, such as by detecting a battery cell or module having a high rate of self-discharge causing a voltage drop when compared to neighboring cells. The electronic controller 56 is also configured to identify a coolant branch from among the branches 44-1, 44-2, 44-3 associated with the battery module 30-1, 30-2, or 30-3 exhibiting the detected onset of the thermal runaway event 60. The electronic controller 56 is further configured to shut off, via the flow-valve(s) 50, the flow of coolant 40 into coolant branches not associated with the battery module exhibiting the onset of the thermal runaway event 60. Such action is intended to particularly and exclusively cool the thermally affected module (to the exclusion of other battery modules in the RESS) and thereby mitigate TRP in the RESS 24.

For example, battery module 30-1 may be identified as exhibiting the onset of the thermal runaway event 60. In such a case, the coolant branches 44-2 and 44-3 would be recognized as associated with battery modules 30-2 and 30-3, i.e., not associated with the affected battery module 30-1. The controller 56 would then shut off the flow of coolant 40 into the coolant branches 44-2 and 44-3 using the multi-way valve 50 or the throttle valves 50-2 and 50-3. The electronic controller 56 may be additionally configured to set, i.e., command or trigger, an alert 66 indicative of the identified battery module exhibiting the onset of the thermal runaway event 60. In other words, the alert 66 may inform a system user or a technician directly via a sensory signal or a trouble code (e.g., via an infotainment display, vehicle data port, vehicle lighting system, etc.) or via a remote server (not shown) that a specific battery module is thermally compromised and is in danger of triggering a TRP.

After shutting off coolant flow into coolant branches not associated with the thermally affected battery module, such as into branches 44-2 and 44-3, the electronic controller 56 may detect degradation of conditions indicative of the onset of the thermal runaway event 60 in the identified battery module 30-1. For example, temperature inside the subject battery module may be one of the conditions indicative of the onset of the thermal runaway event 60 in the battery module 30-1. In such a situation, continued temperature increase in the battery module 30-1, e.g., by a predefined value 68 programmed into the electronic controller 56, as detected via the sensor 62-1, may be considered as meeting the subject degradation condition.

Following such detection of degradation, the electronic controller 56 may command opening, via the flow-valves) 50, the flow of coolant 40 into coolant branches associated with battery module(s) (e.g., module 30-2) neighboring or surrounding the thermally affected battery module (30-1) to further mitigate the TRP in the RESS 24. The electronic controller 56 may be additionally configured to shut off the flow of coolant 40 into the coolant branch (e.g., branch 44-1) associated with the thermally affected battery module when the subject module is identified as having entered full thermal runaway. Such shutting off of coolant flow into the affected battery module is intended to increase coolant flow into the coolant branch(s) associated with neighboring or surrounding battery module(s), such as the module 30-2 to forestall TRP. Additionally, shutting off the coolant flow into the affected battery module, such as 30-1, may prevent coolant line rupture within the coolant branches of neighboring modules, e.g., 44-2 or 44-3, in the event temperatures exceed the coolant pathway temperature capability.

Additionally, after shutting off coolant flow into coolant branches not associated with the identified thermally affected battery module, such as into branches 44-2 and 44-3, the electronic controller 56 may identify an additional battery module, such as module 30-2 or 30-3, exhibiting the onset of the thermal runaway event 60. If such an identification is made, the electronic controller 56 may open, via the flow-valve(s) 50, the flow of coolant 40 into each coolant branch 44-1, 44-2, and 44-3, associated with the respective battery modules 30-1, 30-2, 30-3 in the RESS 24. The opening of each coolant branch would distribute available coolant flow substantially equally across the battery modules in an attempt to generally control thermal stress in the RESS 24.

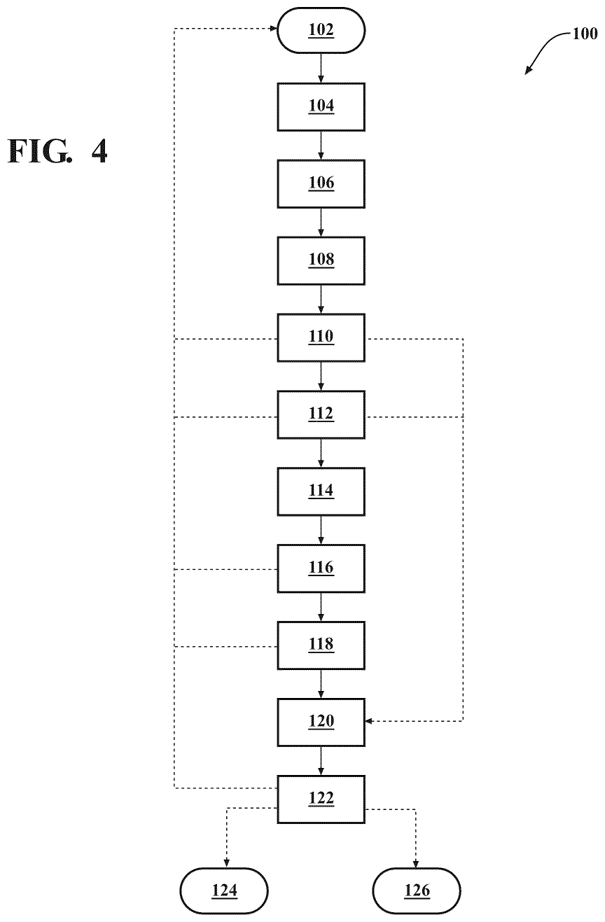

A method 100 of detecting and mitigating thermal runaway propagation (TRP) in a multi-cell rechargeable energy storage system, such as the RESS 24, as shown in FIG. 4 and described below with reference to the structure shown in FIGS. 1-3. The method is specifically intended for use in the RESS employing a main coolant loop connected to a fluid pump, e.g., the main coolant loop 38, and a plurality of coolant branches, e.g., branches 44-1, 44-2, 44-3, arranged in parallel, each configured to receive a portion of the coolant 40 from the main coolant loop. The subject RESS also employs at least one flow-valve 50 configured to regulate and distribute the coolant 40 received from main coolant loop 38 across the plurality of coolant branches 44-1, 44-2, 44-3.

Method 100 commences in frame 102 with monitoring, via the electronic controller 56 (e.g., using corresponding temperature sensors 62-1, 62-2, 62-3 and/or 64) an onset of the thermal runaway event 60 in the RESS 24 while the flow of coolant 40 is delivered to each of the coolant branches 44-1, 44-2, 44-3. After frame 102, the method proceeds to frame 104. In frame 104 the method includes detecting, via the electronic controller 56, an onset of the thermal runaway event 60 in the RESS 24. Following frame 104, the method advances to frame 106. In frame 106, the method includes identifying, via the electronic controller 56, a battery module, e.g., module 30-1, exhibiting the onset of the thermal runaway event 60.

Following completion of frame 106, the method moves on to frame 108. In frame 108, the method includes identifying, via the electronic controller 56, a coolant branch associated with the battery module exhibiting the onset of the thermal runaway event 60, such as the cooling branch 44-1 delivering coolant to the battery module 30-1. After frame 108, the method proceeds to frame 110. In frame 110, the method includes shutting off, via the flow-valve(s) 50 regulated by the electronic controller 56, the flow of the coolant 40 into coolant branches not associated with the thermally affected battery module, e.g., branches 44-2 and 44-3. As described above with respect to FIGS. 1-3, such shutting off of the coolant 40 into coolant branches of non-affected battery modules, is intended to exclusively cool the thermally affected battery module, e.g., module 30-1, and thereby mitigate TRP in the RESS 24.

After frame 110, the method may proceed to frame 112. In frame 112, the method includes setting, via the electronic controller 56, the alert 66 signaling the identification of the thermally affected battery module. The alert 66 may identify the particular battery module and/or the fact that the flow of the coolant 40 has been shut off to branches of other battery modules in the RESS 24. Alternatively, following shutting off of the flow of the coolant 40 into coolant branches not associated with the thermally affected battery module in frame 110 and/or setting the alert 66 in frame 112, method 100 may proceed to frame 114. In frame 114, the method may include detecting, via the electronic controller 56, degradation of conditions indicative of the onset of the thermal runaway event 60 (e.g., temperature increase) in the identified battery module such as the module 30-1.

After frame 114, the method may advance to frame 116 and include opening, via the electronic controller 56 using the flow-valve(s) 50, a flow of the coolant 40 into a coolant branch associated with a battery module neighboring the thermally affected battery module to further mitigate the TRP in the RESS 24. Following frame 116, the method may continue on to frame 118. In frame 118, the method includes identifying the subject thermally affected battery module, (e.g., module 30-1) as having entered full thermal runaway, such as via the corresponding temperature sensor (e.g., sensor 62-1). Subsequent to such an identification, the method includes shutting off, via the electronic controller 56, coolant 40 flow into the thermally affected coolant branch, to thereby increase coolant flow into the coolant branch associated with the neighboring battery module (e.g., branch 44-2).

Method 100 may also proceed from frame 110 or frame 112 to frame 120. In frame 120, the method includes identifying, via the electronic controller 56, an additional battery module (e.g., 30-2 or 30-3) exhibiting the onset of the thermal runaway event 60. After frame 120, the method may advance to frame 122 and include opening, via the electronic controller 56 using the flow-valve(s) 50, flow of the coolant 40 into each coolant branch (e.g., 44-2 or 44-3) associated with the respective battery modules in the RESS 24. Following either frame 110, 112, 116, 118, or 122, the method may loop back to frame 102 for continued monitoring of the RESS 24. Alternatively, if the RESS 24 has entered TRP, the method may shut down current flow in the RESS and conclude in frame 124. In another alternative, if the electrical load on the RESS 24 has been removed, e.g., the vehicle 10 has come to a stop, the power-sources 14 and 20 have been switched off, and the fluid pump 42 has been deactivated, the method may conclude in frame 126.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework and the scope of the appended claims.

What is claimed is:

1. A thermal runaway propagation (TRP) mitigation system for a multi-cell rechargeable energy storage system (RESS) having a plurality of battery cells arranged in individual battery modules, the system comprising:
a cooling subsystem including:
a main coolant loop configured to circulate coolant;
a plurality of coolant branches arranged in parallel, wherein each coolant branch is configured to receive a portion of the coolant from the main coolant loop to adjust temperature of one of the respective battery modules; and
at least one flow-valve configured to regulate and distribute across the plurality of coolant branches the coolant circulated through the main coolant loop; and
an electronic controller in operative communication with the cooling subsystem and configured to:
detect an onset of a thermal runaway event in the RESS;
identify a battery module in the RESS exhibiting the onset of a thermal runaway event;
identify a coolant branch, from among the plurality of coolant branches, associated with the battery module exhibiting the onset of a thermal runaway event; and
shut off, via the at least one flow-valve, a flow of the coolant into coolant branches not associated with the battery module exhibiting the onset of a thermal runaway event to exclusively cool the battery module exhibiting the onset of a thermal runaway event and thereby mitigate the TRP in the RESS.

2. The TRP mitigation system of claim 1, wherein the electronic controller is additionally configured to set an alert indicative of the identified battery module exhibiting the onset of a thermal runaway event.

3. The TRP mitigation system of claim 1, wherein each battery module includes a respective temperature sensor in communication with the electronic controller and configured to detect an onset of a thermal runaway event in the corresponding battery module.

4. The TRP mitigation system of claim 1, wherein, following the shut off of the flow of the coolant into coolant branches not associated with the battery module exhibiting the onset of a thermal runaway event, the electronic controller is additionally configured to:
detect degradation of conditions indicative of the onset of a thermal runaway event in the identified battery module; and
open, via the at least one flow-valve, a flow of the coolant into a coolant branch associated with a battery module neighboring the battery module exhibiting the onset of a thermal runaway event to further mitigate the TRP in the RESS.

5. The TRP mitigation system of claim 4, wherein the electronic controller is additionally configured to shut off coolant flow into the coolant branch associated with the battery module exhibiting the onset of a thermal runaway event when the subject battery module is identified as having entered full thermal runaway to thereby increase coolant flow into a coolant branch associated with the neighboring battery module.

6. The TRP mitigation system of claim 1, wherein, following the shut off of the flow of the coolant into coolant branches not associated with the battery module exhibiting the onset of a thermal runaway event, the electronic controller is additionally configured to:
identify an additional battery module in the RESS exhibiting the onset of a thermal runaway event; and
open, via the at least one flow-valve, flow of the coolant into each coolant branch associated with the respective battery modules in the RESS.

7. The TRP mitigation system of claim 1, wherein the at least one flow-valve is a multi-way valve assembly arranged in a junction between the main coolant loop and the plurality of coolant branches and configured to control a flow of the coolant into each of the coolant branches.

8. The TRP mitigation system of claim 1, wherein the at least one flow-valve is a plurality of throttle valves, each throttle valve arranged in one of the plurality of coolant branches upstream of the corresponding battery module and configured to control a flow of the coolant into the subject coolant branch.

9. The TRP mitigation system of claim 1, wherein each coolant branch includes a one-way valve configured to control a flow of the coolant out of the subject coolant branch.

10. A thermal runaway propagation (TRP) mitigation method for a multi-cell rechargeable energy storage system (RESS) having a plurality of battery cells arranged in individual battery modules, the method comprising
monitoring, via an electronic controller, an onset of a thermal runaway event in the RESS, wherein the electronic controller is in operative communication with a cooling subsystem including:
a main coolant loop configured to circulate coolant;
a plurality of coolant branches arranged in parallel, wherein each coolant branch is configured to receive a portion of the coolant from the main coolant loop to adjust temperature of one of the respective battery modules; and
at least one flow-valve configured to regulate and distribute across the plurality of coolant branches the coolant circulated through the main coolant loop;
detecting, via the electronic controller, an onset of a thermal runaway event in the RESS;
identifying, via the electronic controller, a battery module in the RESS exhibiting the onset of a thermal runaway event;
identifying, via the electronic controller, a coolant branch, from among the plurality of coolant branches, associated with the battery module exhibiting the onset of a thermal runaway event; and
shutting off, via the electronic controller using the at least one flow-valve, a flow of the coolant into coolant branches not associated with the battery module exhibiting the onset of a thermal runaway event to exclusively cool the battery module exhibiting the onset of a thermal runaway event and thereby mitigating the TRP in the RESS.

11. The method of claim 10, further comprising setting an alert, via the electronic controller, indicative of the identified battery module exhibiting the onset of a thermal runaway event.

12. The method of claim 10, wherein each battery module includes a respective temperature sensor in communication with the electronic controller, further comprising detecting an onset of a thermal runaway event in the corresponding battery module using the associated temperature sensor.

13. The method of claim 10, following shutting off of the flow of the coolant into coolant branches not associated with the battery module exhibiting the onset of a thermal runaway event, further comprising:
detecting, via the electronic controller, degradation of conditions indicative of the onset of a thermal runaway event in the identified battery module; and
opening, via the electronic controller using the at least one flow-valve, a flow of the coolant into a coolant branch associated with a battery module neighboring the battery module exhibiting the onset of a thermal runaway event to further mitigate the TRP in the RESS.

14. The method of claim 13, further comprising shutting off, via the electronic controller, coolant flow into the coolant branch associated with the battery module exhibiting the onset of a thermal runaway event, when the subject battery module is identified as having entered full thermal runaway to thereby increase coolant flow into a coolant branch associated with the neighboring battery module.

15. The method of claim 11, following shutting off of the flow of the coolant into coolant branches not associated with the battery module exhibiting the onset of a thermal runaway event, further comprising:
identifying, via the electronic controller, an additional battery module in the RESS exhibiting the onset of a thermal runaway event; and
opening, via the electronic controller using the at least one flow-valve, flow of the coolant into each coolant branch associated with the respective battery modules in the RESS.

16. A motor vehicle comprising:
an electric motor-generator configured to generate torque;
a multi-cell rechargeable energy storage system (RESS) configured to supply electrical energy to the electric motor-generator, the RESS including:
a plurality of battery cells arranged in individual battery modules; and
a cooling subsystem including:
a main coolant loop configured to circulate coolant;
a plurality of coolant branches arranged in parallel, wherein:
each coolant branch is configured to receive a portion of the coolant from the main coolant loop to adjust temperature of one of the respective battery modules; and
each coolant branch includes a one-way valve configured to control a flow of the coolant out of the subject coolant branch; and
at least one flow-valve configured to regulate and distribute across the plurality of coolant branches the coolant circulated through the main coolant loop; and
an electronic controller in operative communication with the cooling subsystem and configured to:
detect an onset of a thermal runaway event in the RESS;
identify a battery module in the RESS exhibiting the onset of a thermal runaway event;
identify a coolant branch, from among the plurality of coolant branches, associated with the battery module exhibiting the onset of a thermal runaway event; and
shut off, via the at least one flow-valve, a flow of the coolant into coolant branches not associated with the battery module exhibiting the onset of a thermal runaway event to exclusively cool the battery module exhibiting the onset of a thermal runaway event and thereby mitigate thermal runaway propagation (TRP) in the RESS.

17. The motor vehicle of claim 16, wherein each battery module includes a respective temperature sensor in communication with the electronic controller and configured to detect an onset of a thermal runaway event in the corresponding battery module.

18. The motor vehicle of claim 16, wherein, following the shut off of the flow of the coolant into coolant branches not associated with the battery module exhibiting the onset of a thermal runaway event, the electronic controller is additionally configured to:
detect degradation of conditions indicative of the onset of a thermal runaway event in the identified battery module; and
open, via the at least one flow-valve, a flow of the coolant into coolant branches associated with battery modules surrounding the battery module exhibiting the onset of a thermal runaway event to further mitigate the TRP in the RESS.

19. The motor vehicle of claim 18, wherein the electronic controller is additionally configured to shut off coolant flow into the coolant branch associated with the battery module exhibiting the onset of a thermal runaway event.

20. The motor vehicle of claim 16, wherein, following the shut off of the flow of the coolant into coolant branches not associated with the battery module exhibiting the onset of a thermal runaway event, the electronic controller is additionally configured to:
identify an additional battery module in the RESS exhibiting the onset of a thermal runaway event; and
open, via the at least one flow-valve, flow of the coolant into each coolant branch associated with the respective battery modules in the RESS.
